(19) United States
(12) Patent Application Publication
(10) Pub. No.: US 2020/0086530 A1
(43) Pub. Date: Mar. 19, 2020

(54) GAS ENTRAINED REMOVABLE MANDREL

(71) Applicants: Matt Wallen, Vail, AZ (US); Jens Rossfeldt, Tucson, AZ (US); Justin Wallen, Tucson, AZ (US)

(72) Inventors: Matt Wallen, Vail, AZ (US); Jens Rossfeldt, Tucson, AZ (US); Justin Wallen, Tucson, AZ (US)

(21) Appl. No.: 16/572,569

(22) Filed: Sep. 16, 2019

Related U.S. Application Data
(60) Provisional application No. 62/732,568, filed on Sep. 17, 2018.

(51) Int. Cl. B29C 33/40; B29C 33/38

(52) U.S. Cl. CPC B29C 33/40; B29C 33/3842

(57) ABSTRACT

This invention involves the incorporation of gas in the matrix of a mandrel. The incorporation of gas, as foam, into the matrix of a mandrel reduces the density of the mandrel. The resulting mandrel is easier to remove from finished product by washout or disintegration. Therefore it is of great value in the use of mandrels in making hollow composite parts.

### RELATED APPLICATIONS

This application claims the benefits of U.S. Provisional Application 62/732,568, filed Sep. 17, 2018.

### FIELD OF THE INVENTION

This invention is related to mandrels or core molds that are used to form hollow composite plastic products.

### BACKGROUND OF THE INVENTION

Composite plastic parts are of great value in industry because of their high strength and light weight. Tubular, simple and complex, structures are produced by wrapping or coating a core mold, or mandrel, with the composite and curing the composite at appropriately high temperature.

After the plastic is hardened, the mandrel is removed, revealing a hollow plastic part.

Multiple problems arise, however, as the mandrel becomes larger and larger. The weight of the mandrel becomes an issue, as the heavier mandrel is cumbersome and difficult to handle. The larger mandrel can also be difficult to wash out of the finished, cured, product.

Core molds, or mandrels, have been made with sand and binders, plaster, plaster mixed with various binders, or fillers such as cenospheres or graphite.

Plaster has been a much used mandrel material or component because it is cheap, easily handled, and has desirable surface characteristics when hardened. However, plaster is heavy with large mandrels.

Current smaller sized removable mandrels can be hard to remove from cured, finished composite product because of the high density of the mandrel. The overall cost of the part is increased, due to the added labor to remove the mandrel.

The solution to these problems is entrainment of air or gas in the mandrel matrix. The entrainment of air or gas in the mandrel matrix can be accomplished in different ways. The entrainment of air or gas can reduce the weight of the mandrel by up to 50% or more and reduces washout times accordingly. The reduction in weight depends on the ratio of air or gas in the final foamed matrix, for example, 20%, 30%, 40%, 50%, or more.

In the construction industry, air is entrained in concrete, usually about 4% to 7%, to increase the resistance of the concrete to freeze-thaw damage. The entrainment of this small amount of air also increases resistance to frost, reduces scaling with de-icing products, and slightly reduces the density of the concrete and increases the yield of a concrete mixture.

However, when more air or gas is entrained in a mandrel, the density of the mandrel is reduced to a greater extent and remarkably is more easily removed from the finished product. Removal of the mandrel from finished product is faster by 25%, 50%, or more.

It is an object of this invention to reduce the density or weight of the resulting mandrel. It is a further object of this invention to make the mandrel more easily removed from the finished composite product.

Knott (U.S. Pat. No. 7,678,189 B2) discloses the creation of a foamed plaster for construction uses. This is a different use. Foamed plaster is used as an insulator over metal in permanent applications in construction.

In another use (casting metals), United States Gypsum Company has a product, Hydroperm, which increases the volume of plaster for molds for casting metals by over 50%, recommended to use to increase the volume 70-100%. This allows foam plaster castings, which are produced as female cavities, to be able to allow water or other out-gassing from contacting molten metal to escape from the casting. This stops explosions or defects from forming in the metal.

The novelty in the present invention is realized in carefully tuning the density of the foam to be strong enough not to yield to the processing forces associated with plastic/composite processing (i.e. autoclave, vacuum, etc) and the necessity to remove the mandrel after the solidification of the desired plastic without damaging the plastic product.

### SUMMARY OF THE INVENTION

Air or gas is entrained within a mandrel as it is formed producing a mandrel of lower density, less weight. After the mandrel is wrapped or coated with raw composite-plastic, heated to cure the raw composite plastic, said mandrel is easily removed from the cured, plastic product. Compared to a mandrel that is not air or gas entrained, the air or gas entrained mandrel is much more easily removed or washed out. The decreased density and structure of the mandrel produced by the incorporation of foam is easily washed out or disintegrated with a stream of water.

### DETAILED DESCRIPTION OF THE INVENTION

The air-entrained mandrel can be formed in various ways. The object is to trap bubbles of air or gas within the matrix of the mandrel during the forming of the mandrel. The solid mandrel resulting from entraining air or gas is significantly less dense by 20%, 30%, 40%, 50% or more compared to a mandrel that is not entrained with air or gas. In addition to this decrease in density, the resulting mandrel is more easily removed or washed out from the finished product requiring 20% to 50% or greater less time and effort. As little as 5% or 10% foam as a percent of matrix volume can provide benefits.

Air is a mixture of gases under conditions for creating a mandrel. Entraining air is entraining gas.

Gas can be entrained in a mandrel with a matrix comprised of plaster, Portland cement, sodium silicate, starch, caboxymethylcellulose, etc.

Pneumatic Production of Air-entrained Mandrel

Compressed air or gas mixed with a foaming agent produces foam. The foam is mixed with the mandrel matrix creating a foam matrix, and the foam matrix is then cast into the desired shape. Upon hardening of the foam matrix mixture, the air or gas entrained mandrel is removed. The mandrel can then be further dried, wrapped in raw composite, and the raw composite cured, as appropriate.

The foaming agent can be in a plaster solution. Compressed air is mixed with foaming agent in the plaster solution. The foam matrix is then cast into the desired shape.

Other filler additives such as cenospheres, glass beads, talc, sand graphite, graphene, etc. can also be utilized to vary properties of the foamed matrix.

Multiple hinders or additives can be utilized to enhance the properties of the matrix, such as polyvinylpyrrolidone (PVP), PEO, PVA, PU, or other liquid dispersible polymers. Other matrix forming compounds such as starch, caboxymethylcellulose, and acetate are also helpful in modifying the foamed matrix properties. These additives may increase strength, vary viscosity, enhance removal rate, or even change the thermal properties of the material, including coefficient of thermal expansion and thermal conductivity.

Chemical Production of Air-entrained Mandrel

Air or gas can alternatively be entrained by utilizing an internal chemical reaction to generate gas in the mixture of the mandrel material prior to forming the mandrel. Appropriate chemicals are added to the mandrel matrix which is then cast into the desired shape. Gas is entrained in the foam matrix mandrel as the mandrel hardens. After hardening, the gas-entrained mandrel is removed and utilized, as appropriate, for forming a composite product.

As can be understood, foam can be incorporated into many different mandrels.

Other filler additives such as cenospheres, glass beads, talc, sand, graphite, graphene, etc. can also be utilized to vary properties of the foamed matrix. Portland cement can also be utilized.

Multiple hinders or additives can be utilized to enhance the properties of the matrix, such as PVP, PEO, PVA, PU, or other liquid dispersible polymers. Other matrix forming compounds such as starch, caboxymethylcellulose, and acetate are also helpful in modifying the foamed matrix properties. These additives may increase strength, vary viscosity, enhance removal rate, or even change the thermal properties of the material, including coefficient of thermal expansion and thermal conductivity.

Production of Air-entrained Mandrel with Dense Outer Shell

The invention further relates to the utilization of a hybrid foam system in which a dense outer shell is first cast into the desired mold cavity. The shell is much stronger than the foam matrix and produces a closed surface to better distribute force. The shell also makes sealing and handling easier. The shell is then filled with foamed matrix material, either pneumatic or chemical produced, and the foamed matrix material is allowed to harden. The hybrid shape is then post processed.

The invention can be applied in several ways, depending on what process requirement is followed. The shell may be precast and cured, and then the foam matrix applied or co-cured. The resultant water-removable shape, depending on the thickness of the shell and strength of the foam/shell hybrid, has greater strength for processing, such as under autoclave conditions.

Examples (Illustrating the Invention and not to be Limiting)

A mixture of plaster is added to 60% by volume foam mixed at a ratio of 40 parts water:1 part foaming agent. This foamed matrix is then cast into a female cavity and allowed to harden. The resultant mandrel is then post cured to result in a mandrel that is about 50% lighter than a similar plaster mandrel.

Alternatively, the plaster can contain any of a number of binders. The plaster containing binder is then mixed with the foam to produce the foamed matrix. One example is 2% polyvinylpyrrolidone in the plaster solution, mixed with an approximately equal volume of foam to produce the foamed matrix. The mixture with foam can be varied, producing a mandrel of, for example, 30% less weight.

Alternatively, a foaming agent is added to the plaster solution at 0.5%, air is injected until the volume of the plaster increases about 20%, 30%, 40% to 50%, this foamed matrix is cast into a cavity and allowed to harden.

Alternatively, gas is generated in the plaster solution containing foaming agent with chemicals, such as vinegar and baking soda, and the foamed matrix is cast and allowed to harden.

Depending on the foaming agent, it can be used at many concentrations to effectively produce the foamed matrix.

As can be understood by one skilled in the art, there are many ways to utilize this invention.

Utilization of in situ polymerization is also useful in modifying the physical properties of the foam matrix.

What is claimed:

1. A mandrel for utilization in the fabrication of a plastic/composite which is formed with entrained air or gas.

2. The mandrel of claim 1 containing 5% or more of its volume as air or gas, as foam.

3. The mandrel of claim 1 produced by pneumatic means.

4. The mandrel of claim 1 produced by mixing foam into the mandrel matrix before hardening the matrix.

5. The mandrel of claim 1 produced by chemical means to entrain the gas in the matrix.

6. A mandrel that is formed utilizing entrained gas, a hardening matrix, and a binder.

7. The mandrel in claim 6 which contains a controlled amount of entrained gas greater than 5%.

8. The mandrel in claim 6 which contains a liquid matrix that is able to harden to a desired shape upon setting or curing or drying.

9. The mandrel in claim 6 which contains a binder that is able to impart special properties to the mandrel matrix including strength, dispersibility, thermal properties and/or color.

10. A mandrel formed with a dense outer shell and filled with foamed matrix material.
